(19) United States
(12) Patent Application Publication
(10) Pub. No.: US 2006/0070101 A1
(43) Pub. Date: Mar. 30, 2006

(54) Broadcast receiver

(76) Inventor: Tadahiro Hirahara, Kumagaya-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/234,598

(22) Filed: Sep. 23, 2005

(30) Foreign Application Priority Data
Sep. 27, 2004 (JP) 2004-280701

(51) Int. Cl. H04N 5/445

(52) U.S. Cl. 725/58; 725/59

(57) ABSTRACT

A main body of a broadcast receiver can receive a large amount of input information in a short time through a keyboard. The main body can discriminate through which an input operation has been performed a remote controller and the keyboard. The main body comprises a remote-controlled operation receiving unit provided to receive a remote-controlled operation input, a universal serial bus (USB) terminal, an input identification unit for identifying between the presence of the remote-controlled operation input and the presence of an operation input through the USB terminal, and a display mode switching unit for switching display modes of a display unit in response to an identification result from the input identification unit.

### CROSS-REFERENCE TO RELATED APPLICATIONS

This application is based upon and claims the benefit of priority from prior Japanese Patent Application No. 2004-280701, filed Sep. 27, 2004, the entire contents of which are incorporated herein by reference.

### BACKGROUND

1. Field

Embodiments of the invention relate to improvement in a broadcast receiver for receiving, for example, digital television broadcast, etc. More specifically, one embodiment of the invention relates to a device configured to enable receiving input operations from a plurality of kinds of operation units.

2. Description of the Related Art

As is well known, in recent years, there has been a movement to accelerate the acceptance of digital television broadcasts. For example, in Japan, a number of different types of digital broadcasting schemes are currently available, including satellite digital broadcasts such as broadcasting satellite (BS) digital broadcasts and 110° communication satellite (CS) digital broadcasts, as well as terrestrial digital television broadcasts.

It has become possible for a digital broadcast receiver to receive a digital television broadcast and to digitally record the received program or reproduce the recorded program by connecting digital recording equipment with a large capacity such as a hard disk drive (HDD).

Nowadays, it is possible for the digital broadcast receiver to specify any digital recording equipment for recording a program and reproducing the recorded program by configuring a network including a single digital broadcast receiver and multiple sets of digital recording equipment.

In the broadcast receiver making the plurality of sets of the digital recording equipment connectable with network thereto, it becomes important allow a user to easily manage programs recorded in the respective digital recording equipment and to quickly retrieve the desired recorded program to reproduce it.

A prior patent document (for example, Jpn. Pat. Appln. KOKAI Publication No. 10-136275) discloses a configuration that a television receiver with an Internet receiving function can recognize a connection state through a telephone line even if the television receiver outputs a sound of a television signal from its loudspeaker.

### SUMMARY

In the case of a digital television broadcast receiver which can be connected with a network and can be connected to a plurality of sets of digital recording equipment, it is necessary to manage programs for video recording thereof and manage the recorded programs. Further, the broadcast receiver might perform E-mail transmission.

In such an environment, though an interactive interface between the broadcast receiver and a user is required, at present, only a remote controller and an operation key provided with the main body of the broadcast receiver exists as the interactive interface. The current operating means, however, is inconvenient for the user because the operating means cannot input a large amount of input information quickly and in a short while. In particular, a large number of characters (e.g., information such as a title and a comment) are needed for management information sometimes and it is required to improve the current operating means.

An embodiment of the invention is to provide a user-friendly broadcast receiver by allowing a user to easily distinguish which operation unit performs an input operation while providing a large amount of the input information in a short while and providing a keyboard connection terminal with the main body of the broadcast receiver.

The broadcast receiver according to the embodiment comprises a receiving means for receiving a digital broadcast signal, a processing means for decoding to reproduce a program from the broadcast signal received by the receiving means, a recording means for selectively recording the program decoded by the processing means into a plurality of sets of digital recording equipment connected so as to input and output information in a prescribed information transmission form, respectively, a remote-controlled operation receiving unit provided to receive a remote-controlled operation input, a universal serial bus (USB) terminal, an input identifying means for identifying the case when the remote-controlled operation input is input and the case when an operation input is input though the USB terminal and a display mode switching means for switching a display mode in response to a identification result from the input identifying means.

According to the above-mentioned invention, the user can input a large amount of input information through a keyboard in a short while, use the remote controller for an operation from a position distant therefrom, select the use of the keyboard and the remote controller, and further, the user can easily determine, by a display unit, which operating unit is used for its input operation.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an exemplary embodiment of a digital television broadcast receiver and an example of a network configured around the broadcast receiver as a center;

FIG. 2 is an exemplary block diagram for explaining a principal signal processing system of the broadcast receiver in the embodiment in FIG. 1;

FIG. 3 is an external view for explaining a remote controller of the broadcast receiver in the embodiment in FIG. 1;

FIG. 4 is an exemplary flowchart of the broadcast receiver in the embodiment in FIG. 1 that controls digital recording equipment to record a program thereby;

FIG. 5 is an exemplary embodiment of a program table displayed on a display unit connected to the broadcast receiver in the embodiment in FIG. 1;

FIG. 6 is an exemplary flowchart of the operations in the case that the program is reproduced from the recording equipment by the broadcast receiver in the embodiment in FIG. 1;

FIG. 7 is an exemplary embodiment of a navigation menu displayed on the display unit when reproduction operations are performed in the broadcast receiver in the embodiment in FIG. 1;

FIG. 8 is an exemplary view for explaining a state in which items of video recorded programs are selected from the navigation menu;

FIG. 9 is an exemplary view for explaining an example of a list display screen which indicates recently recorded programs and can be obtained from the navigation menu;

FIG. 10 is an exemplary view for explaining a photograph reproduction function of the broadcast receiver in the embodiment in FIG. 1;

FIG. 11 is an exemplary view for explaining an example of an E-mail incoming screen of the broadcast receiver in the embodiment in FIG. 1;

FIG. 12 is an exemplary view for explaining an example of an E-mail display screen of the broadcast receiver in the embodiment in FIG. 1;

FIG. 13 is an exemplary view for explaining an example of an input switching screen in an analog system of the broadcast receiver in the embodiment in FIG. 1;

FIG. 14 is an exemplary view for explaining an example of a favorite program list display screen of the broadcast receiver in the embodiment in FIG. 1;

FIG. 15 is an exemplary view for explaining an example of a keyword retrieval screen of the broadcast receiver in the embodiment in FIG. 1;

FIG. 16 is an exemplary view for explaining an example of a connected equipment list display screen of the broadcast receiver in the embodiment in FIG. 1;

FIG. 17 is an exemplary view for explaining an example of a list display screen of programs recorded in specified connected equipment of the broadcast receiver in the embodiment in FIG. 1;

FIG. 18 is an exemplary view for explaining an example of a list display screen of programs with keyword retrieval performed therefore among programs recorded in the specified connected equipment of the broadcast receiver in the embodiment in FIG. 1;

FIG. 19 is an exemplary view for showing a state in which the keyboard is connected to the broadcast receiver in the embodiment in FIG. 1;

FIG. 20A and FIG. 20B are exemplary views showing examples of display screens for explaining states in which the screens of the broadcast receiver in the embodiment in FIG. 1 are switched in response to the used operating units; and

FIG. 21 is an exemplary flowchart for explaining operations by which the screens of the broadcast receiver in the embodiment in FIG. 1 are switched in response to the used operating units.

### DETAILED DESCRIPTION

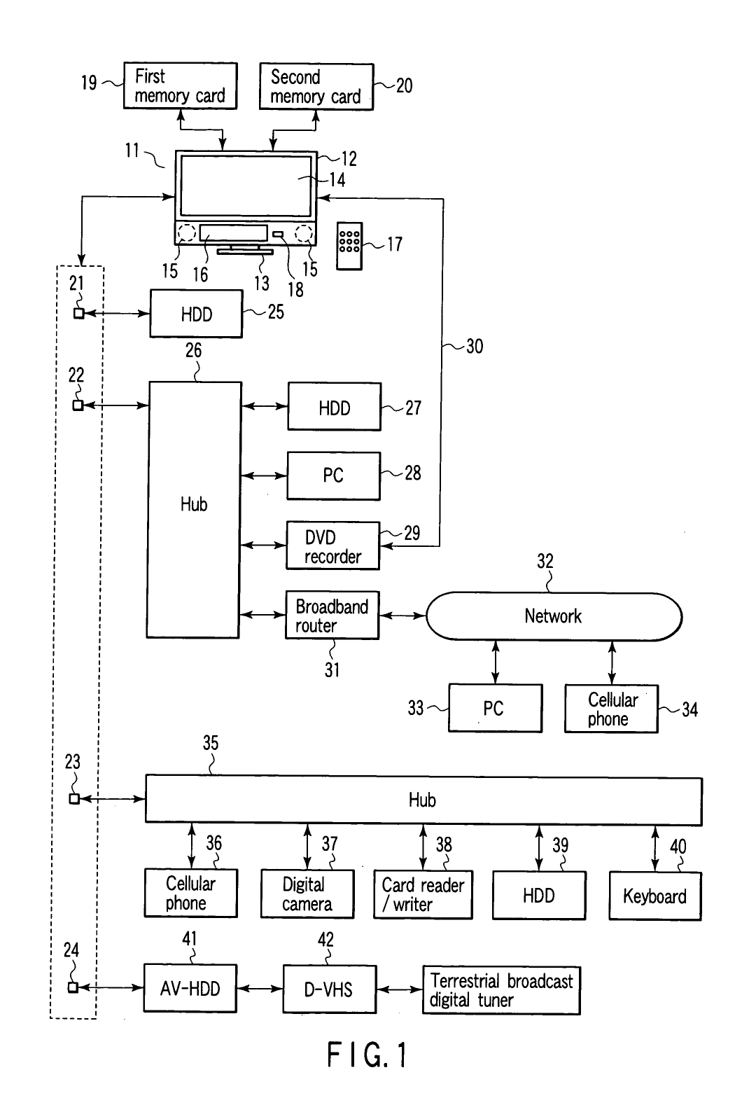

Hereinafter, embodiments of the invention will be explained by referring the drawings in details. FIG. 1 schematically shows an embodiment of the external appearance of a digital television broadcast receiver 11 and a network system configured around the broadcast receiver 11.

The broadcast receiver 11 composed mainly of a thin cabinet 12 and a support base 13 making the cabinet 12 raised and supported. The cabinet 12 is provided with a flat panel type video display unit 14 composed of a liquid crystal display panel or the like, a loud speaker 15, an operation unit 16, and a light receiving unit (remote-controlled operation receiving unit) 18 to receive operation information transmitted from a remote controller 17.

The broadcast receiver 11 is adapted to receive a first detachable memory card 19 such as a secure digital (SD) memory card, a multimedia card (MMC) or a memory stick, and performs recording/reproducing of information about such as a program or a photograph to and from the first memory card 19.

The broadcast receiver 11 is further adapted to receive a second detachable memory card (IC card) 20 with, for example, contract information recorded thereon and performs recording/reproducing of information to and from the second memory card 20.

The broadcast receiver 11 is provided with a first local area network (LAN) terminal 21, a second LAN terminal 22, a universal serial bus (USB) terminal 23 and an I.LINK® terminal 24.

Among these parts, the first LAN terminal 21 is used as a LAN-compatible HDD dedicated port. The first LAN terminal 21 is connected to a LAN-compatible HDD 25 being a network attached storage (NAS). The first LAN terminal 21 is used to record/reproduce information to and from the HDD 25 through a network (e.g., Ethernet network).

As mentioned above, by providing the first LAN terminal 21 to be the LAN-compatible HDD dedicated port, the broadcast receiver 11 can record a program with a high image quality to the HDD 25 without being influenced by other network environment or the status of use of the network.

The second LAN terminal 22 is used as a general LAN-compatible port using Ethernet. The second LAN terminal 22 is connected to equipment, for example, a LAN-compatible HDD 27, a personal computer (PC) 28 and a digital versatile disk (DVD) recorder 29 with a built-in HDD through a hub 26.

Since digital information communicated through the second LAN terminal 22 is control information, the DVD recorder 29 utilizes a dedicated analog transmission path 30 to transmit analog information of video and sound to the broadcast receiver 11.

The second LAN terminal 22 is connected to, for example, a network 32 such as the Internet via a broadband router 31 connected to the hub 26 and used to communicate information between a PC 33, a cellular phone 34 or the like, and the broadcast receiver 11 via the network 32.

The USB terminal 23 is used as a general USB-compatible port, connected to, for example, a cellular phone 36, a digital camera 37, a card reader/writer 38 for a memory card, an HDD 39 or a keyboard 40. The USB terminal 23 is used to make information transmissions between the equipment and the broadcast receiver 11.

The foregoing I.LINK® terminal 24 serially connects an AV-HDD 41, digital (D)—video home system (VHS) 42, etc. and supports information transmissions between the equipment and the broadcast receiver 11.

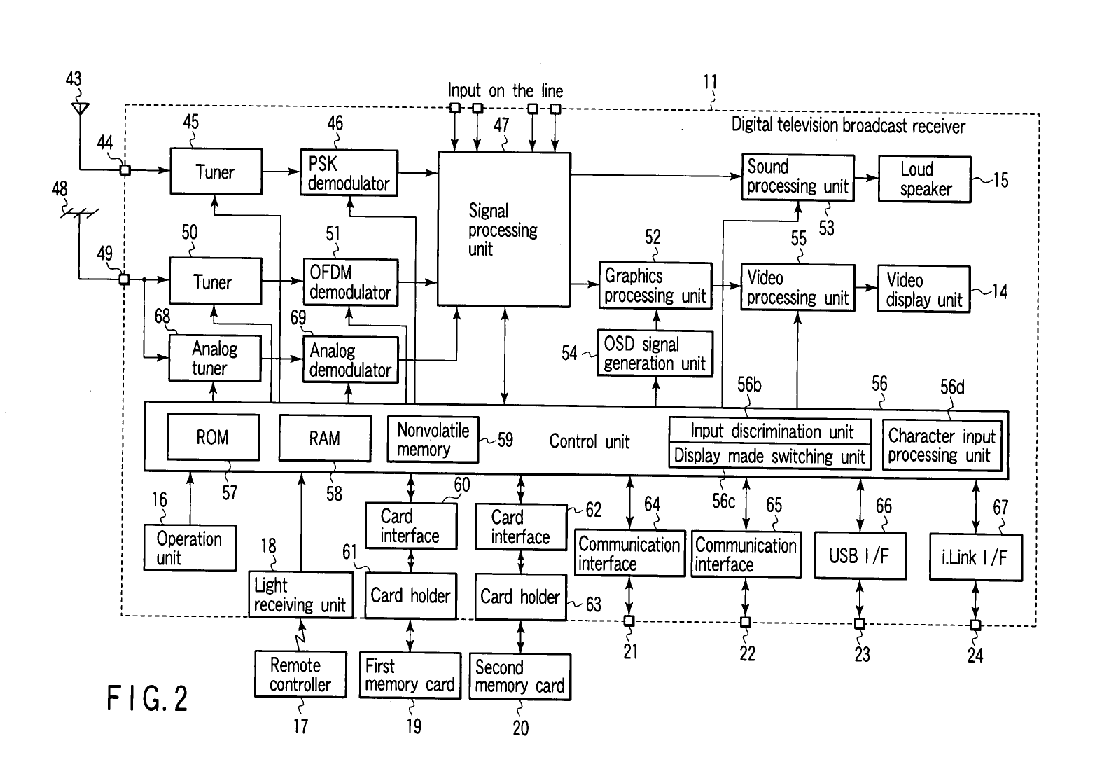

FIG. 2 shows the principal signal processing system of the foregoing broadcast receiver 11. That is, a satellite digital television broadcast signal, received at a first antenna 43 for receiving BS/CS digital broadcast, is supplied to a tuner 45 for satellite digital broadcast through an input terminal 44, and the tuner 45 tunes a broadcast signal of a desired channel.

The broadcast signal tuned by the tuner 45 is fed to a phase shift keying (PSK) demodulator 46 to be demodulated to a digital video signal and a digital sound signal, which are output to a signal processor 47.

A terrestrial digital television broadcast signal, received at a second antenna 48 for receiving terrestrial digital television broadcast, is supplied to a tuner 50 for the terrestrial digital television broadcast via an input terminal 49. The tuner 50 tunes the broadcast signal of the desired channel.

The broadcast signal tuned by the tuner 50 is supplied to an orthogonal frequency division multiplexing (OFDM) demodulator 51 to be demodulated to a digital video signal and a digital sound signal then output to the signal processor 47.

This signal processing system also features an analog tuner 68 to receive a terrestrial wave analog signal. The signal received by the analog tuner 68 is demodulated by an analog demodulator 69 and output to the signal processor 47.

The signal processor 47 selectively conducts prescribed digital signal processing of the digital video signals and sound signals supplied from the PSK demodulator 46 and from the OFDM demodulator 51. The signal processor 47 processes the video signals and analog signals supplied from the analog demodulator 69 and further from the line input terminals, and outputs an output signal to a graphics processor 52 and a sound processor 53.

Among the processors, the graphics processor 52 has a function to superimpose an on screen display (OSD) signal generated from an OSD signal generator 54 on the digital video signal supplied from the signal processor 47 and to output the superimposed signal. The graphics processor 52 can selectively output the video signal output from the signal processor 47 and the OSD signal output from the signal generator 54 and also combine to output both outputs so that both outputs configure a half of a screen, respectively.

The digital video signal output from the graphics processor 52 is supplied to a video processor 55. The video processor 55 converts the input digital video signal into an analog video signal in a format possible to be displayed on the video display unit 14 and outputs the analog video signal to the video display unit 14 to produce a video display.

The sound processor 53 converts an analog sound signal in a format that can be reproduced by the loudspeaker 15 and outputs the analog sound signal to the loudspeaker 15 to make a sound reproduction.

As further shown in FIG. 2, the broadcast receiver 11 further comprises a control unit 56. The control unit 56 has a built-in central processing unit (CPU), which receives operation information from the operation unit-16, or receives operation information transmitted from the remoter controller 17 and respectively controls each part so as to reflect operation contents thereto.

In this case, the control unit 56 mainly uses a read only memory (ROM) 57 with a control program to be executed by the CPU stored thereon, a random access memory (RAM) 58 to provide an operation area to the CPU and a nonvolatile memory 59 to which a variety of items of setting information and control information are stored.

The control unit 56 is connected to a card holder 61 to which the first memory 19 can be attached through a card interface 60. The control unit 56 is adapted to support the exchange of information transmission with the first memory card 19 attached to the card holder 61 through the card interface 60.

The control unit 56 is further connected to a card holder 63 to which a second memory card 20 can be attached through a card interface 62. The control unit 56 thereby can communicate information with the second memory card 20 attached to the card holder 63 through the card interface 62.

The control unit 56 is also connected to the first LAN terminal 21 through a communication interface 64. The control unit 56 thereby can communicate with the LAN-compatible HDD 25 connected to the first LAN terminal 21 through the communication interface 64. In this case, the control unit 56 has a dynamic host configuration protocol (DHCP) server function and assigns an internet protocol (IP) address to the LAN compatible HDD 25 connected to the first LAN terminal 21 to control the HDD 25.

The control unit 56 is further connected to the second LAN terminal 22 through a communication interface 65. The control unit 56 thereby can communicate with any equipment (refer to FIG. 1) connected to the second LAN terminal 22 through the communication interface 65.

The control unit 56 is further connected to the USB terminal 23 through an USB interface (I/F) 66. The control unit 56 thereby can communicate with any equipment (refer to FIG. 1) connected to the USB terminal 23 through the USB interface 66.

Furthermore, the control unit 56 is connected to the I.LINK® terminal 24 through an I.LINK® interface 67. Thereby, the control unit 56 can communicate with any equipment (refer to FIG. 1) connected to the I.LINK® terminal 24 through the I.LINK® interface 67.

Furthermore, the control unit 56 includes an input discrimination unit 56b, a display mode switching unit 56c and a character input processing unit 56d. The input discrimination unit 56b, which may be called an “operation device discriminator,” is adapted to discriminate between a presence of input signaling at the remote-controlled operation receiving unit 18 and the presence of an input at the USB terminal 23 of FIG. 1. The display mode switching unit 56c, which may be called a “display state switching section,” is adapted to switch a mode of a display screen of a display unit in response to a discrimination result of the input determination unit 56b. The character input processing unit 56d is adapted to process a character input signal from the remote-controlled operation receiving unit 18 and the USB terminal 23 of FIG. 1.

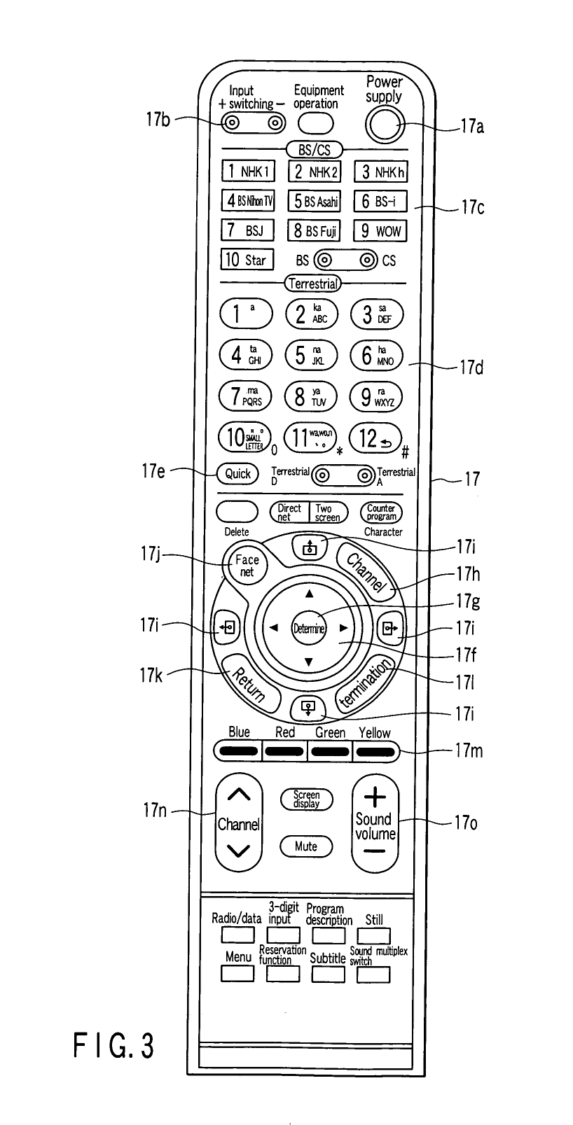

FIG. 3 shows the external view of the remote controller 17. The remote controller 17 mainly comprises a power supply key 17a, input switching keys 17b, direct tuning keys for satellite broadcast channels 17c, direct tuning keys of terrestrial broadcast channels 17d, a quick key 17e, a cursor key 17f, a determination key 17g, a program table key 17h, page switching keys 17i, a FACENET™ (navigation) key 17j, a return key 17k, a terminate key 17l, color keys in blue, red, green and yellow 17m, a channel up down key 17n, a sound volume adjusting key 17o, etc.

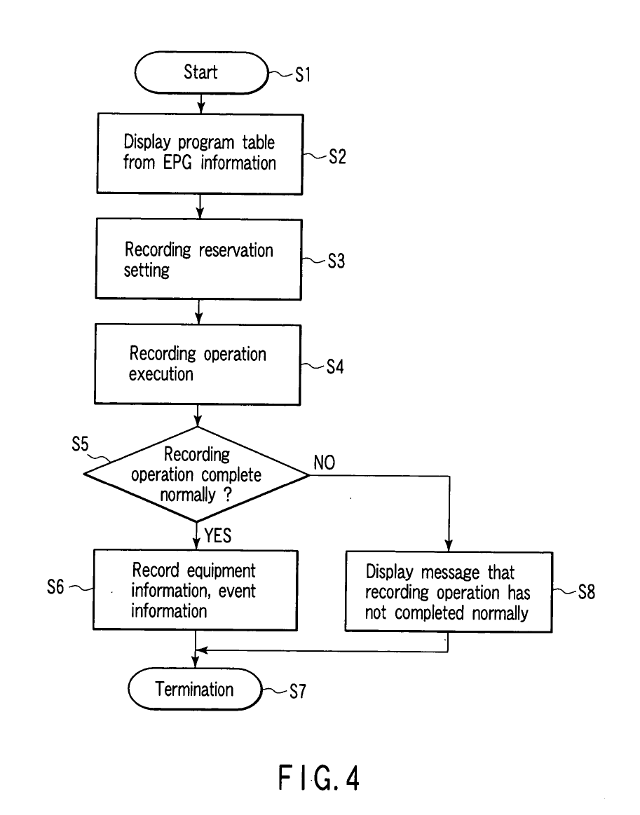

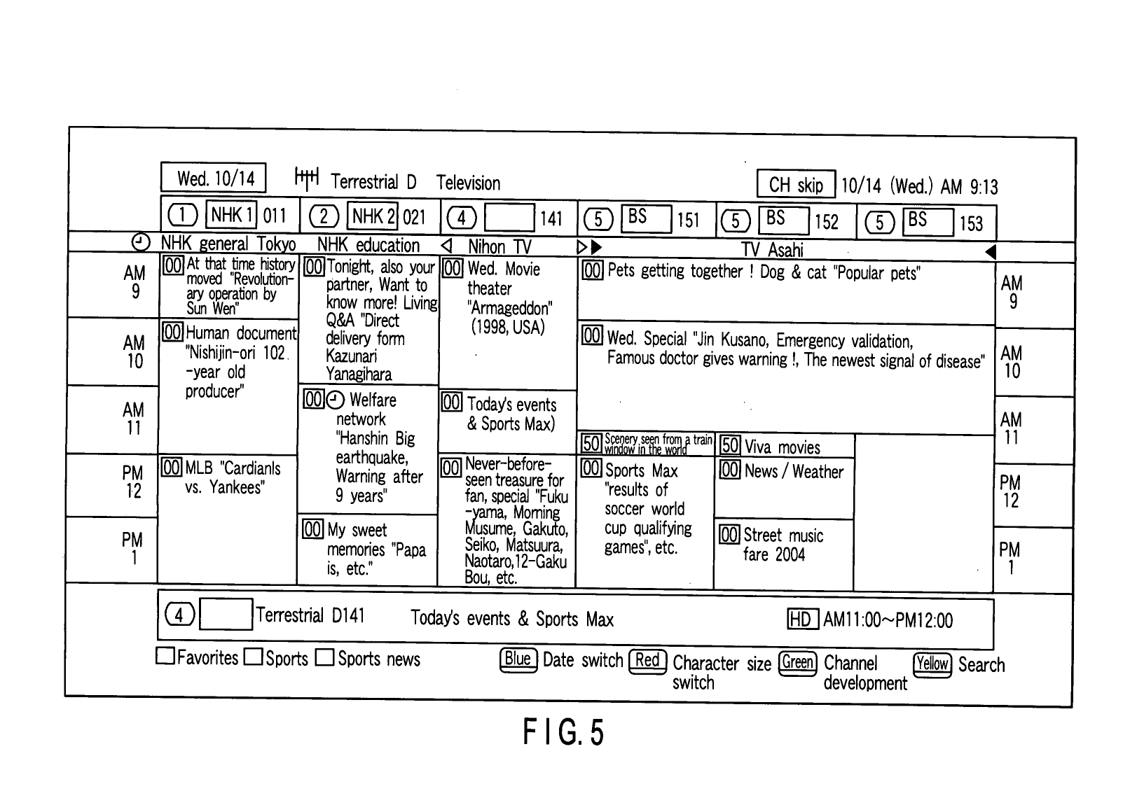

FIG. 4 shows the flowchart for explaining the operations of the broadcast receiver 11 in recording a program into the digital recording equipment with each of the equipment connected to the terminals 21-24 of the broadcast receiver 11. When processing is started resulting from a request of the recording of the program (block S1), the control unit 56 of FIG. 3 displays the program table as shown in FIG. 5 on the basis of electronic program guide (EPG) information acquired from the broadcast signal (block 2).

The user then executes recording reservation setting of the desired programs on the basis of the displayed program table (block S3). In this setting, the broadcast receiver 11 selects the program to be recorded and also selects to set the digital recording equipment to which the reservation-set program is recorded.

The control unit 56 executes a recording operation so as to record the reservation-set program into the reservation-set digital recording equipment when it has reached the preset time for a recording reservation (block S4).

The control unit 56 then determines whether or not the program recording operation has normally completed, and if it is determined that the operation has completed normally (Yes, in block S5), the broadcast receiver 11 records equipment information (equipment ID, equipment name, shared holder name, etc.) to specify the digital recording equipment which has performed recording. The broadcast receiver 11 further records event information (event ID, channel number, title, content explanation, category, recording range, image quality mode, etc.) related to the recorded program into the nonvolatile memory 59 (block S6) and terminates this processing (block S7).

If it is determined that the operation has not completed normally (No, in block S5), the control unit 56 of FIG. 3 displays the message indicating the fact that the operation has not completed normally onto the display unit 14 of FIG. 1 (block S8) and terminates this processing (block S7).

According to the recording operations described above, the user can arbitrarily select multiple sets of digital recording equipment connected to each terminal 21-24 of the broadcast receiver 11 and record programs sequentially.

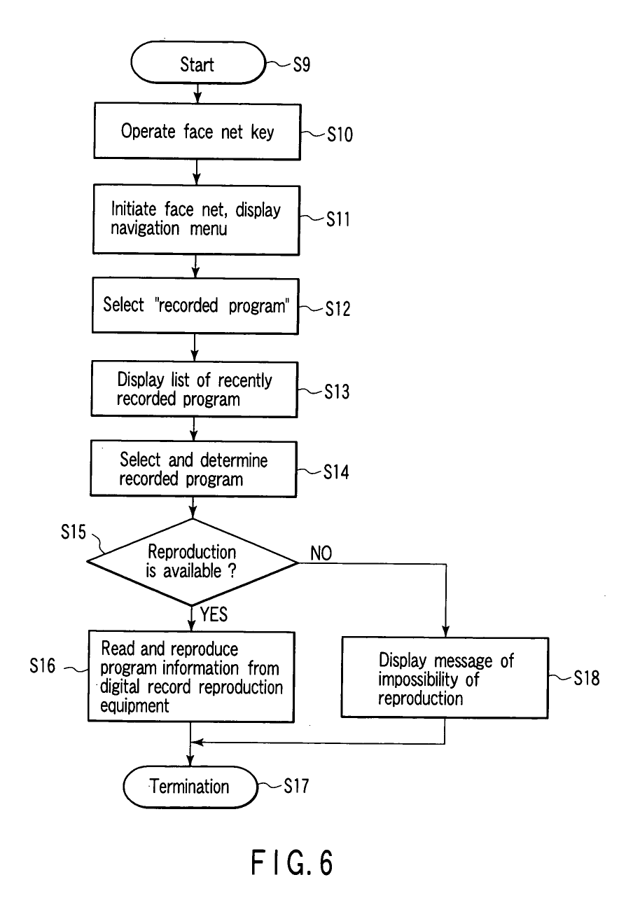

FIG. 6 shows the flowchart for explaining operations to quickly retrieve the desired program and reproduce it among a variety of programs recorded in the plurality of sets of the digital recording equipment as mentioned above. When the processing begins (block S9), the user operates the FACENET™ key 17j of the remote controller 17 (block S10). (Note: FACENET™ is a graphical guide screen for the user.)

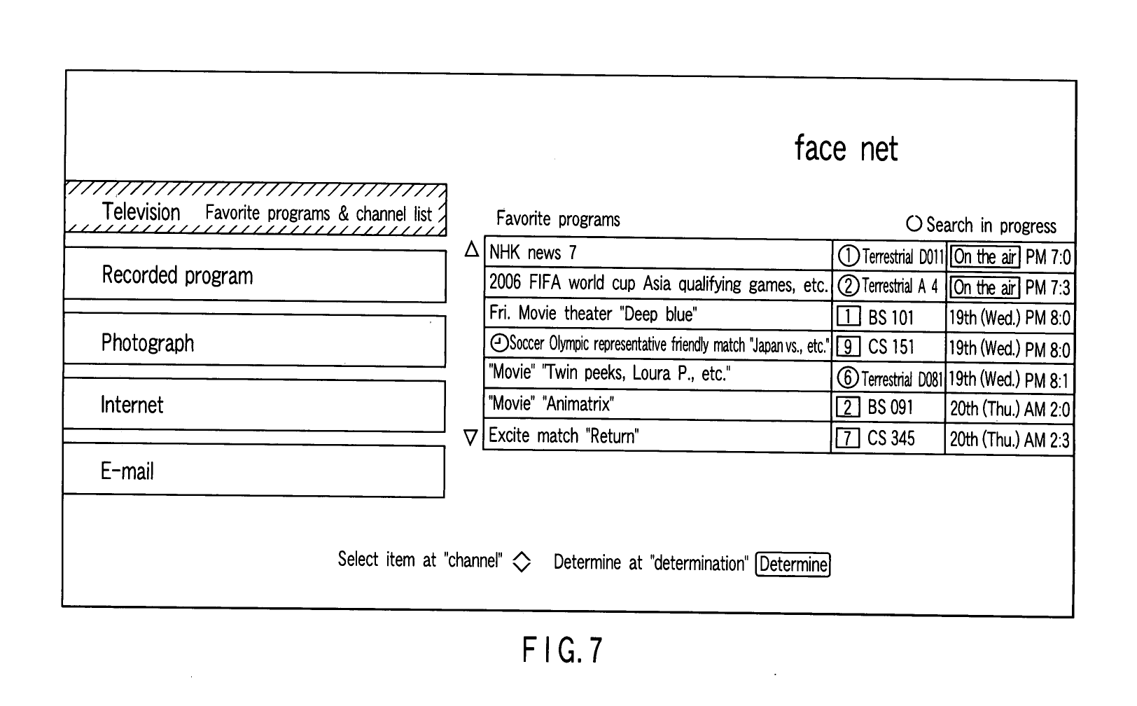

The control unit 56 then starts up the FACENET™ (navigation) and displays the navigation menu as shown in FIG. 7 onto the video display unit 14 (block S11). Five items of “television”, “recorded program”, “photograph”, “Internet” and “E-mail” are selectively provided in this menu. The selected items are displayed on a screen in different color from other items, and a state in which the “television” item is selected is indicated by hatching in FIG. 7.

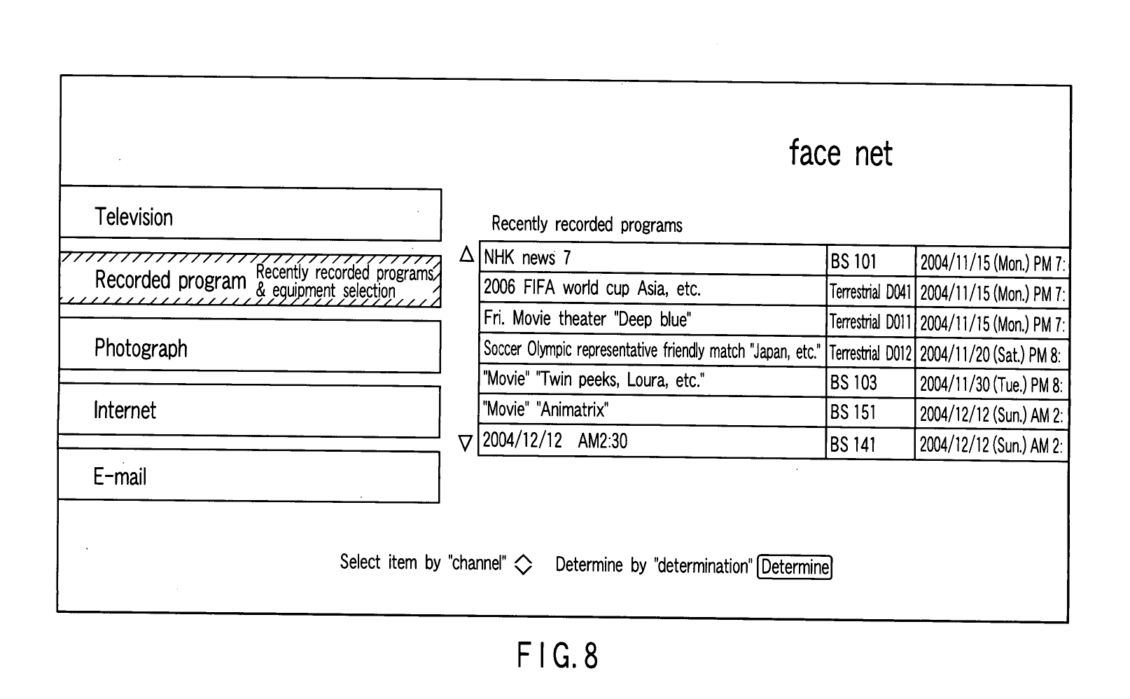

Here, it is assumed that the user operates the cursor key 17f on the remote controller 17 and selects the “recording program” item (block 12). The control unit 56 then is brought into a state of selection of the “recording program” item as shown in FIG. 8.

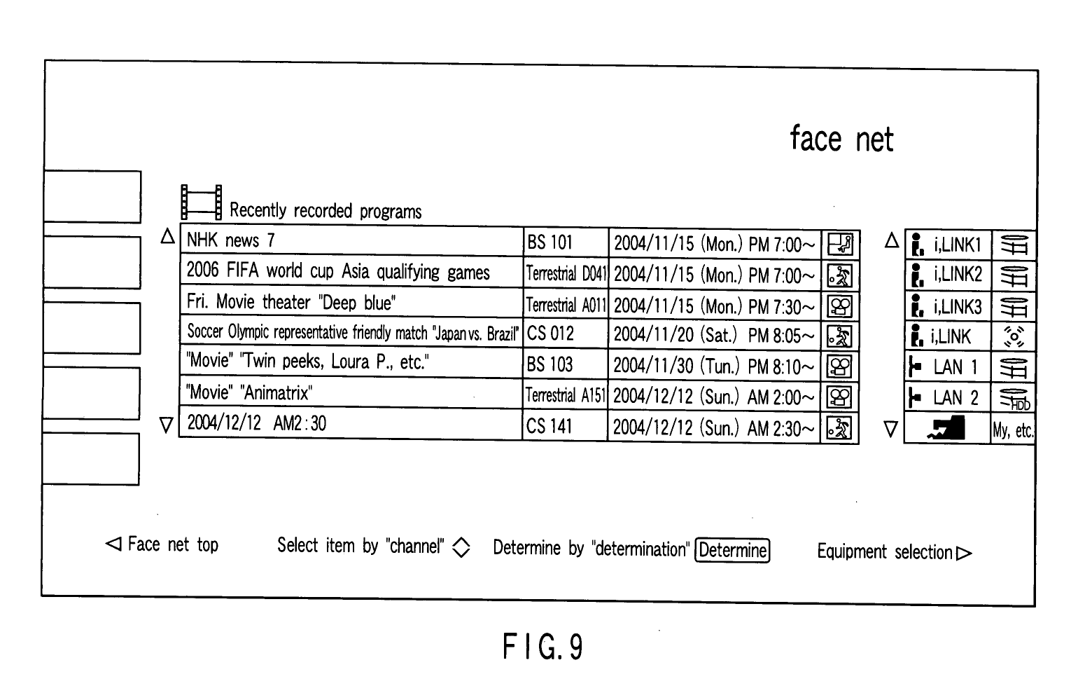

In this state, when the user operates the determination key 17g of the remote controller 17 (block S13), the control unit 56 displays a list of the recently recorded programs onto the video display unit 14 as shown in FIG. 9. In this program list, the title, broadcast channel, recording date, day of the week, time, category, etc., are displayed as information indicating the recorded program.

The list of the recently recorded programs is created by referring to equipment information specifying the digital recording equipment that has conducted the recording and event information in relation to recorded programs recorded on the nonvolatile memory 59 in reservation recording of the programs explained in FIG. 4. In this list, it is possible to display information indicating thirty-five programs at a maximum as far back as the reproduction-requested program recorded therein, regardless of the digital recording equipment with the program recorded therein. Having displayed seven programs in a list form in FIG. 9, the user can see the list of thirty-five programs by operating the cursor key 17f to scroll the display. If the user operates the page switching keys 17i of the remote controller 17, the user can skip the seven programs displayed in a list at once.

When the user operates the cursor key 17f of the remote controller 17 to select information indicating the desired program from the list of the recently recorded programs and operates the determination key 17g to determine it (block S14), the control unit 56 specifies the digital recording equipment with the selected and determined program recorded therein from information recorded in the nonvolatile memory 59 and determines whether or not the program is possible to be reproduced (block S15).

Whether the program can be reproduced or not is determined by comprehensively comparing various conditions in recording and in reproducing. For example, this may be conducted by determining one or more of the following: (i) whether or not the broadcast receiver 11 is connected to the digital recording equipment with the reproduction-requested program recorded therein, (ii) whether or not power is tuned on to the digital recording equipment with the reproduction-requested program recorded therein, (iii) whether or not the program is still recorded in the targeted digital recording equipment, etc.

Referring still to FIG. 6, if it is determined that the program can be reproduced (Yes, in block S15), the control unit 56 reads out information about the reproduction-requested program from the targeted digital recording equipment and controls the broadcast receiver 11 to reproduce the program (block S16) then terminates this processing (block S17).

If it is determined that the program can not be reproduced (No, in block S15), the control unit 56 displays a message indicating the fact that the requested program can not be reproduced onto the video display unit 14 and terminates this processing (block S17).

According to the forgoing reproduction operations, since the broadcast receiver 11 has a navigation function to display, in a list, the thirty-five recorded programs as far back as from the newest recorded program regardless of the digital recording equipment with the desired program recorded therein, the user can easily manage the programs recorded in a plurality of sets of digital recording equipment. Accordingly, it becomes possible to quickly retrieve and reproduce the desired program by locating the desired program using the cursor key 17f and selecting the desired program among programs displayed in a list form through use of the determination key 17g.

Considering the increase in the number of connected sets of the digital recording equipment and the recorded programs, it becomes impractical to display in a list the whole of programs recorded in the plurality of sets of the recording equipment. As the embodiment stated above, it is a practical setting to hardly cause substantial trouble for the user to display at a list up to a predetermined number of programs (e.g., thirty-five programs) as far back as from the newest recorded program.

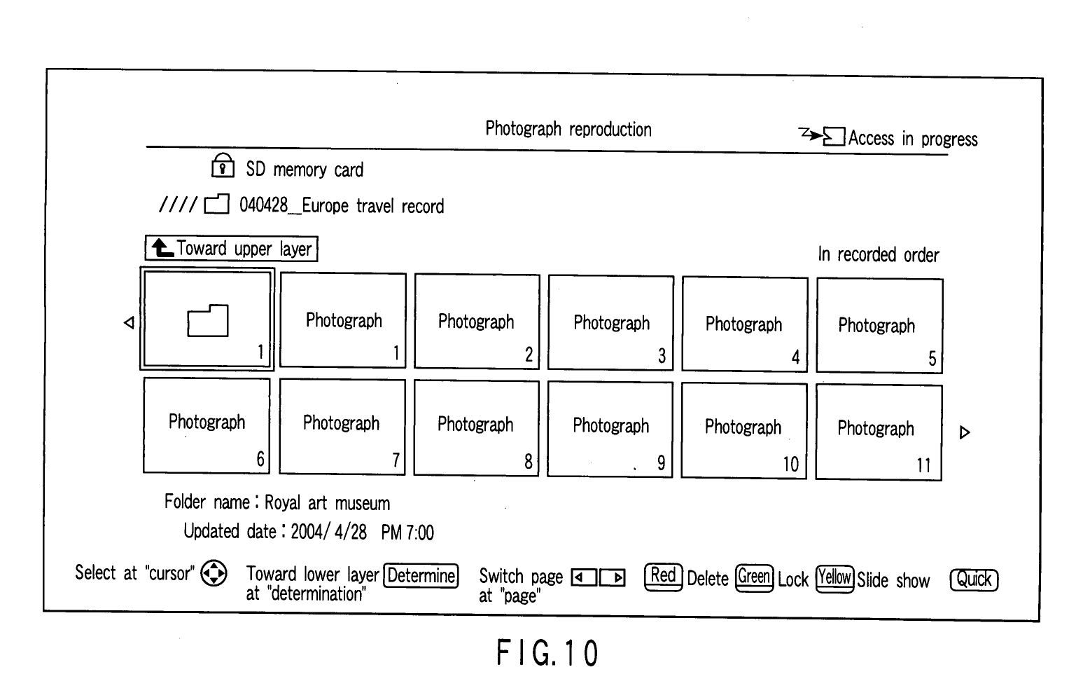

The broadcast receiver 11 further comprises a photograph reproduction function. The broadcast receiver 11 can display, in a list form, such a plurality of photographs recorded on the SD memory card being the first memory card 19 attached to the card holder 61 by selecting to determine the item of “photograph” among the navigation menu shown in FIG. 7 displayed by operating the FACENET™ key 17j of the remote controller 17. In this case, the user should specify the digital recording medium or digital recording equipment (digital camera). As a result, the photograph list shown in FIG. 10 is displayed.

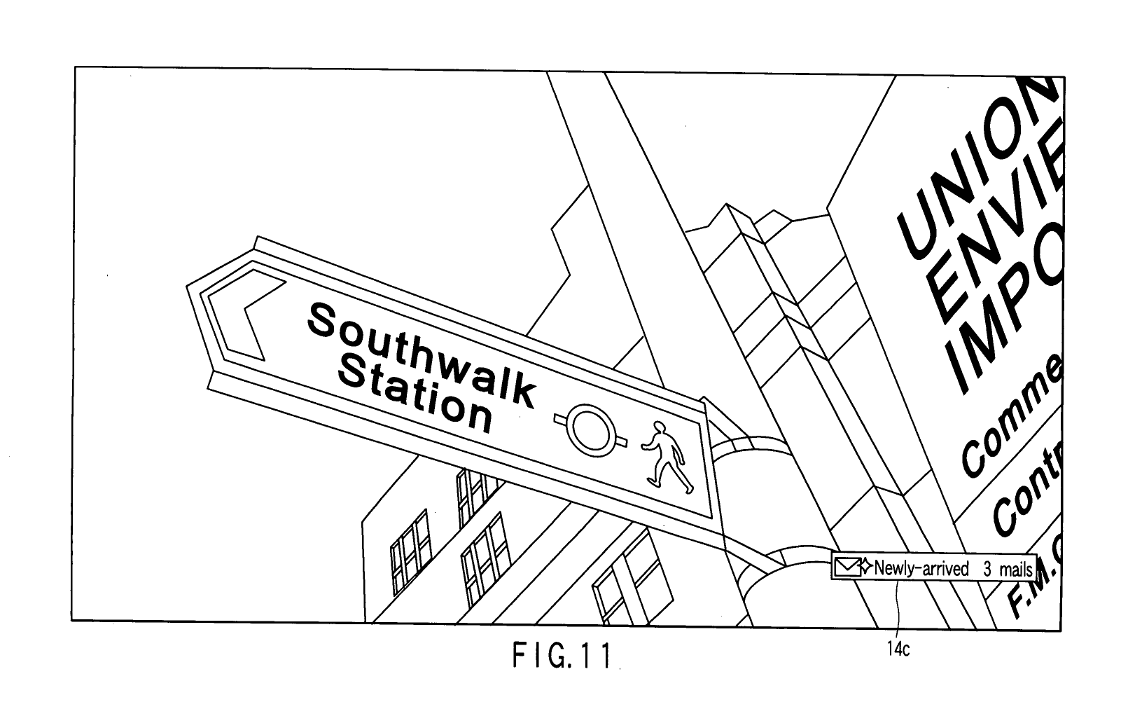

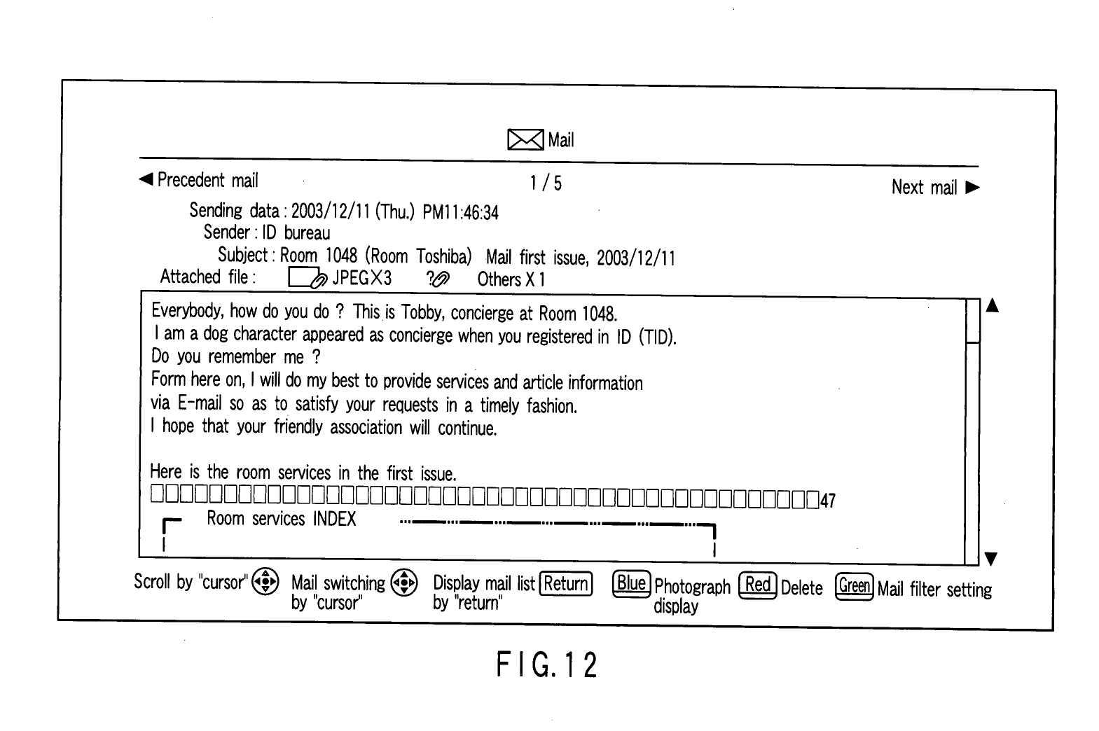

The broadcast receiver 11 periodically accesses to a server to determine the incoming state of the E-mail, and if there is incoming of the E-mail, the broadcast receiver 11 can display an incoming message 14c such as “newly arrived three mails” onto a display screen on the video display unit 14 as shown in FIG. 11. In a state of display of the incoming message, the broadcast receiver 11 can open the E-mail on the video display unit 14 as shown in FIG. 12 only by operating the determination key 17g of the remote controller 17.

The broadcast receiver 11 also can specify the desired PC 28, 33 to transmit the E-mail and read out the received E-mail even by selecting and determining the item of “E-mail” from the navigation menu shown in FIG. 7.

The broadcast receiver 11 can switch the video displayed on the screen of the video display unit 14 on a page basis by operating the page switching keys 17i of the remote controller 17. Otherwise stated, the cursor key 17f of the remote controller 17 is composed of four keys corresponding to each direction of upward, downward and right, left so as to move the cursor in directions of upward, downward and right, left on the screen.

In other words, for example, if the user operates the page switching key 17i corresponding to the cursor key 17f to move the cursor upward, a current display screen can be switched to the video existent on the upper side of the display screen. Due to this page switching function, it becomes possible to select the desired screen in a shorter amount of time than when scrolling the screen by operating the cursor key 17f.

Since the page switching keys 17i of FIG. 3 are provided in accordance with the cursor key 17f, the moving directions can be easily recognized by the user. The page switching keys 17i can switch such screens of the program table shown in FIG. 5 and of the list of recently recorded programs shown in FIG. 9.

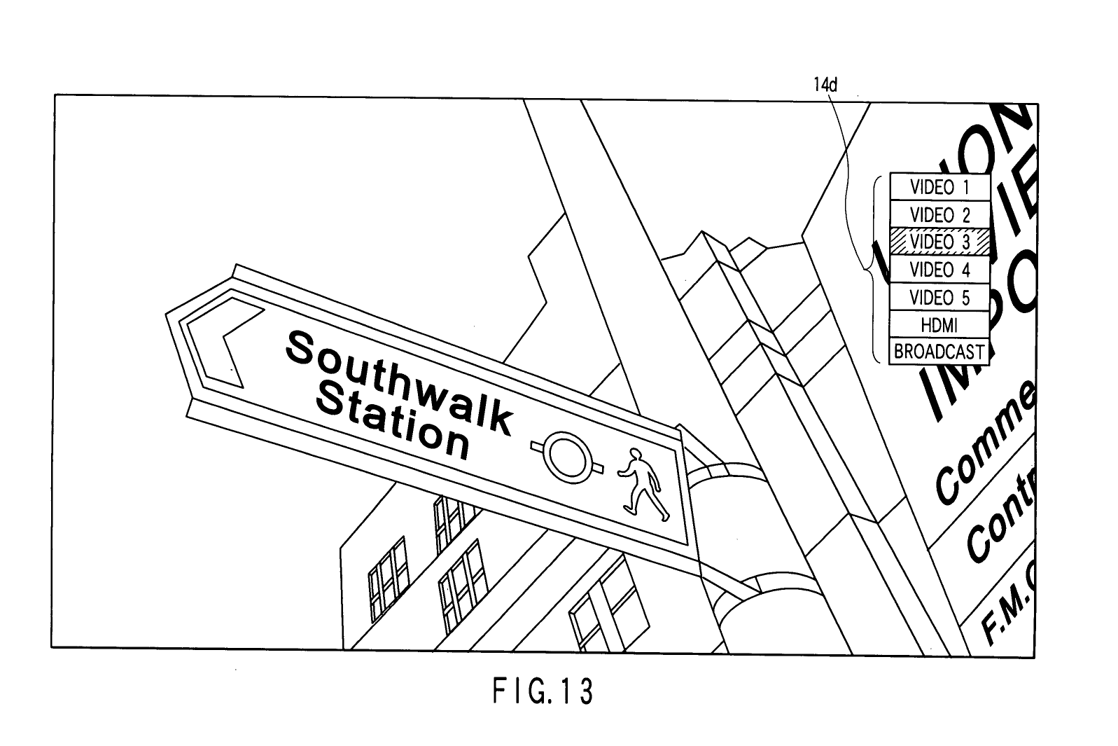

Further, the input switching key 17b is a key to switch the video input terminals of the analog system and structured to be selectively operated between “+” side and “−” side. The switching state of the video input terminals are made using the OSD display on the display screen of the video display unit 14 as shown in FIG. 13.

If the user switches the switching key 17b of FIG. 3 on the “+” side, the video input terminals are circularly switched in the forward direction as VIDEO 1-VIDEO 2-VIDEO 3-VIDEO 4-VIDEO 5-high definition multimedia interface (HDMI)-Broadcast-VIDEO 1. If the user switches the switching key 17b on “−” side, the video input terminals are circularly switched in the backward direction as Broadcast-HDMI-VIDEO 5-VIDEO 4-VIDEO 3-VIDEO 2-VIDEO 1-Broadcast. Conventionally, since the user can circularly switch the video input terminals only in the forward direction, though the user is forced to be in inconvenience, the remote controller 17 can improve the operability by adding the function of circular switching in the forward direction.

Since the video input switching by means of the input switching key 17b adopts so-called “a preceding input system” in which only the OSD display is changed and the screen is changed by bringing the operation into a stop for a prescribed time period in a state that the input switching key 17b is continuously pressed, the burden of changing in screen at every operation of the input switching key 17b.

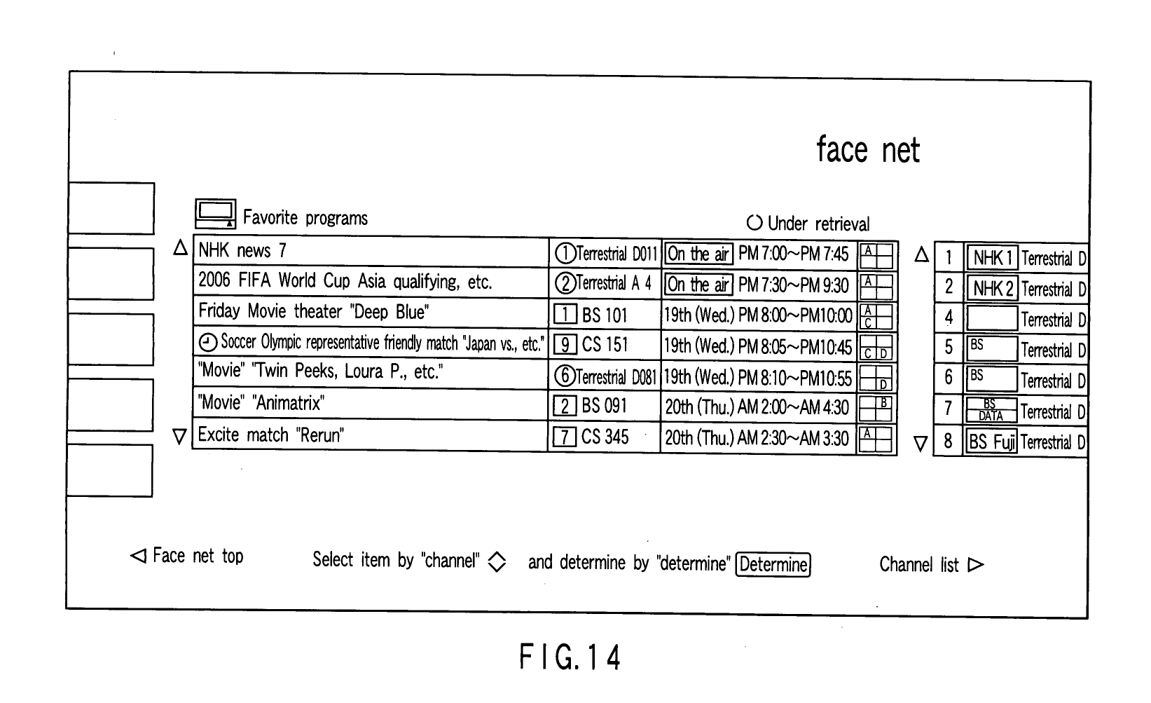

Further, if the user inputs preference information in relation to channels, categories and keywords, the broadcast receiver 11 automatically retrieves the programs corresponding to the preference information up to one week before a time point of the input of the preference information and makes a screen display as a favorite program list as shown in FIG. 14. The user also can select a specific program from the favorite program list to set a recording reservation.

This favorite program list is displayed by selecting the “television” items on the navigation menu and deciding by the determination key 17g. In the retrieval of the favorite programs, the user can set four types of combinations of channels, categories and keywords (referred to as “combinations A-D”).

The combination A can be set as the combination of, for example, soccer as the category, world as the keyword and NHK as the channel. Combination B can be set as the combination of, for example, baseball as the category, Japan as the keyword and Nihon TV as the channel. As for the favorite program list, as shown in the column of the right side in the favorite program list shown in FIG. 14, which combination of A-D retrieves each retrieved program is displayed. A plurality of combinations A-D are displayed for the programs with overlapped preference information.

The broadcast receiver 11 operates a yellow key 17m on the remote controller 17 in the display state of the program list shown in FIG. 5 then displays a keyword retrieval screen. The user inputs four items of the category, keyword, date and channel onto this keyword retrieval screen then the user can automatically retrieve the program up to one week hence from the time point of the input of the four items to display the retrieval result in a list form.

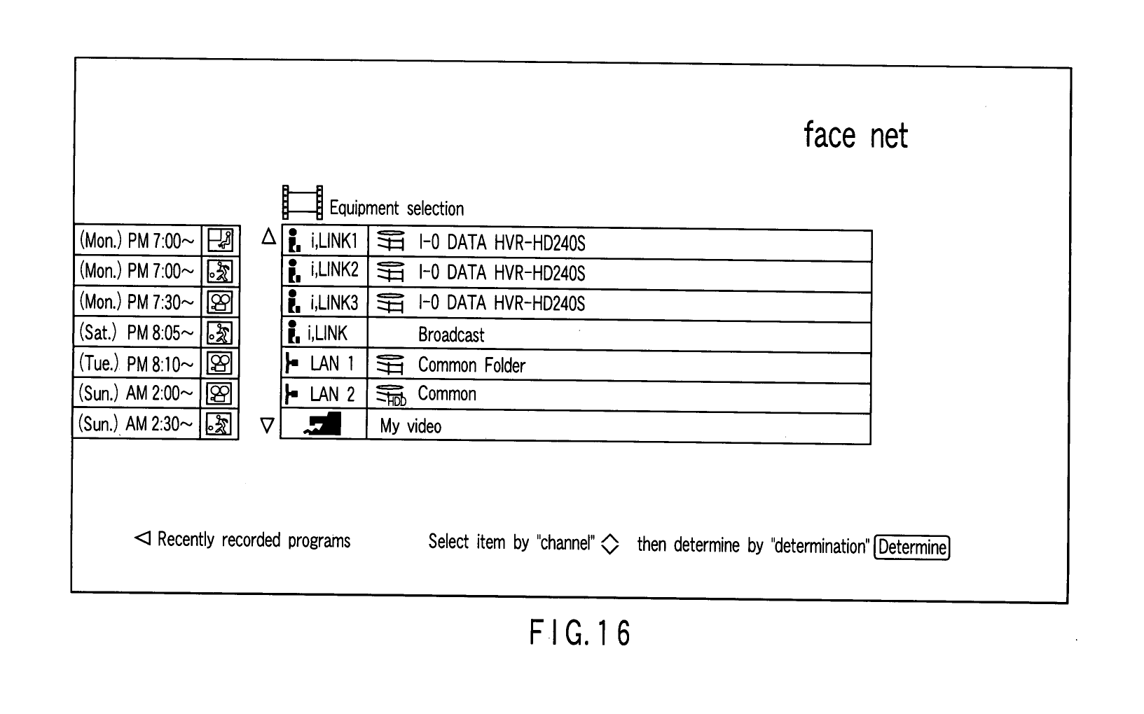

The broadcast receiver 11, as shown in FIG. 16, can display the list screen of the connection equipment (hereafter “connection equipment list”) by scrolling the screen on the right side of the list table of the recently recorded program shown in FIG. 9. In the connection equipment list, all of the equipment connected to each terminal 21-24 (however, if a broadband router 31 is connected, not the whole but up to the router 31) can be made in the list display.

In this list in FIG. 16, an icon indicating that the LAN 1 is a LAN compatible HDD dedicated port is attached to the LAN 1 corresponding to the first LAN terminal 21, and an icon indicating that the LAN 2 is a generic LAN compatible port is marked to the LAN 2 corresponding to the second LAN terminal 22.

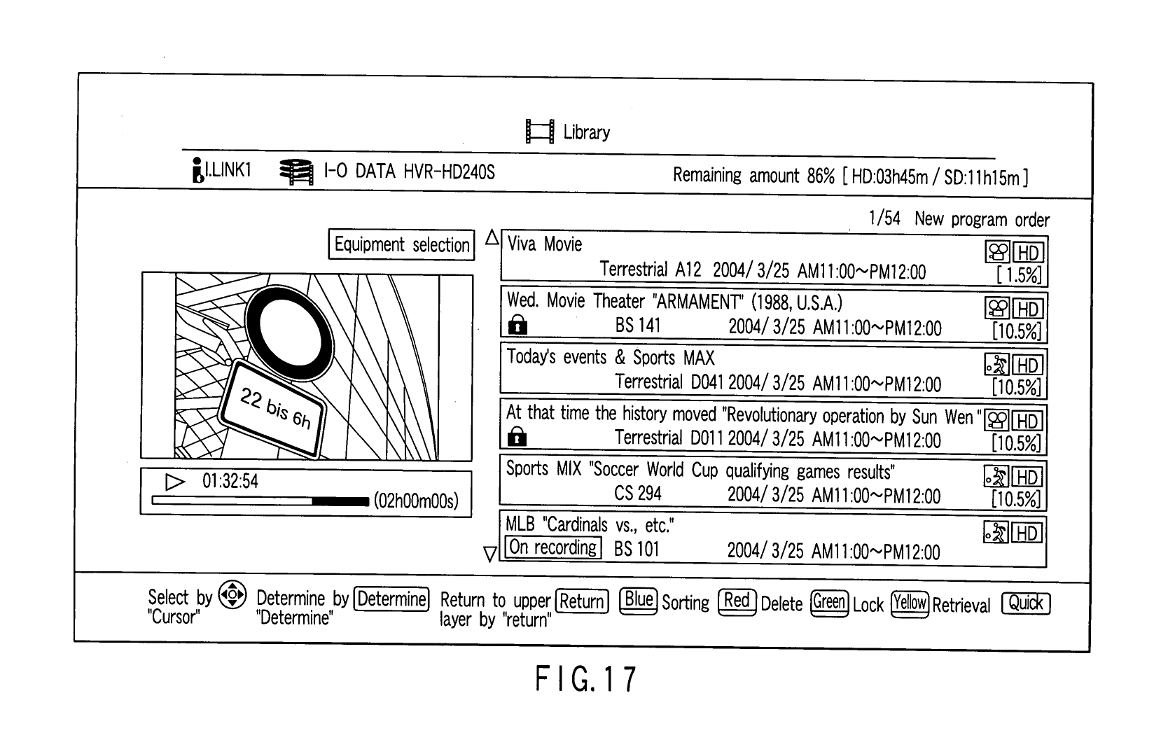

If the user selects the desired digital recording equipment from the display screen of the connection equipment list and determines by the determination key 17g, the list of the programs recorded in the selected and determined digital recording equipment is displayed as a library as shown in FIG. 17.

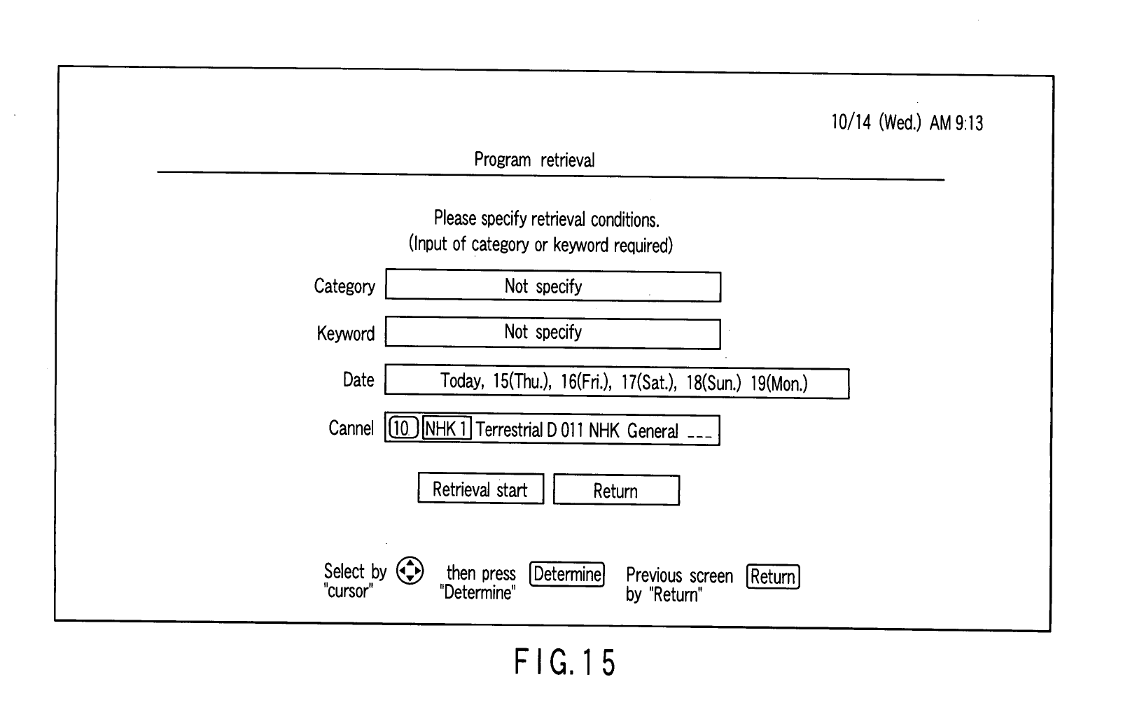

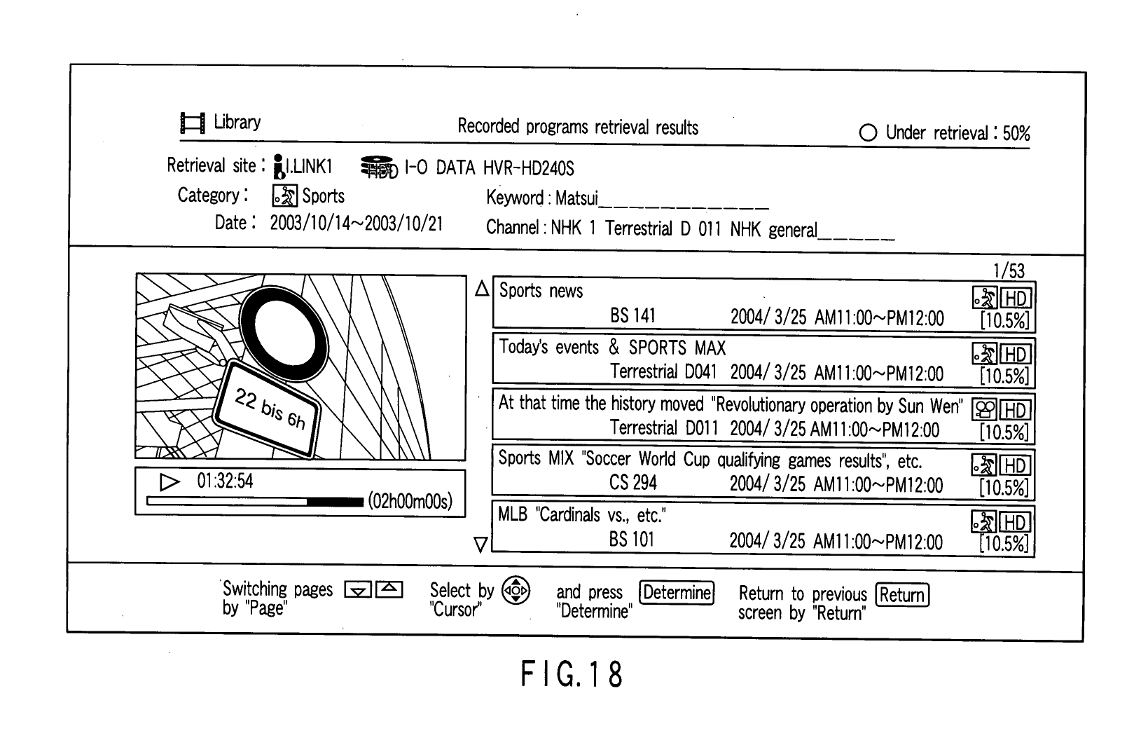

If the user operates the yellow key 17m of the remote controller 17 in the display state of the library screen, the keyword retrieval screen shown in FIG. 15 is displayed. Then, if the user inputs the four items of the category, keyword, data and channel into the keyword retrieval screen, the programs corresponding to the retrieval conditions are retrieved among the programs recorded in the selected and determined digital recording equipment and displayed in the list form as shown in FIG. 18.

As described above, there are many sets of the external connection equipment and if it becomes possible to manage the recorded programs and transmit/receive E-mail, there exists the case that a large amount of information input such as keyword retrieval, a comment input, a memo input and an E-mail input in a short while is required sometimes. The broadcast receiver 11 then has a USB terminal to enable the keyboard to be connected thereto.

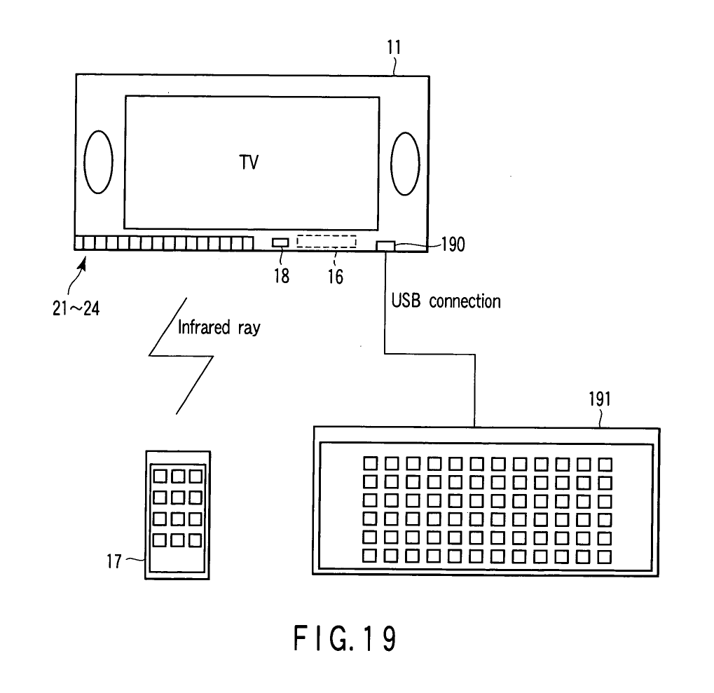

FIG. 19 shows the aspect in which a USB terminal 190 is provided with the broadcast receiver 11 and a keyboard 191 is connected to the USB terminal 190 through a cable.

The user may operate with any of a plurality of character input devices, including one or more wireless character input device such as the remote controller 17, one or more wired character input devices such as the keyboard 191 or any combination thereof. The broadcast receiver 11 can display in a user-friendly form which information input unit has been used by the user.

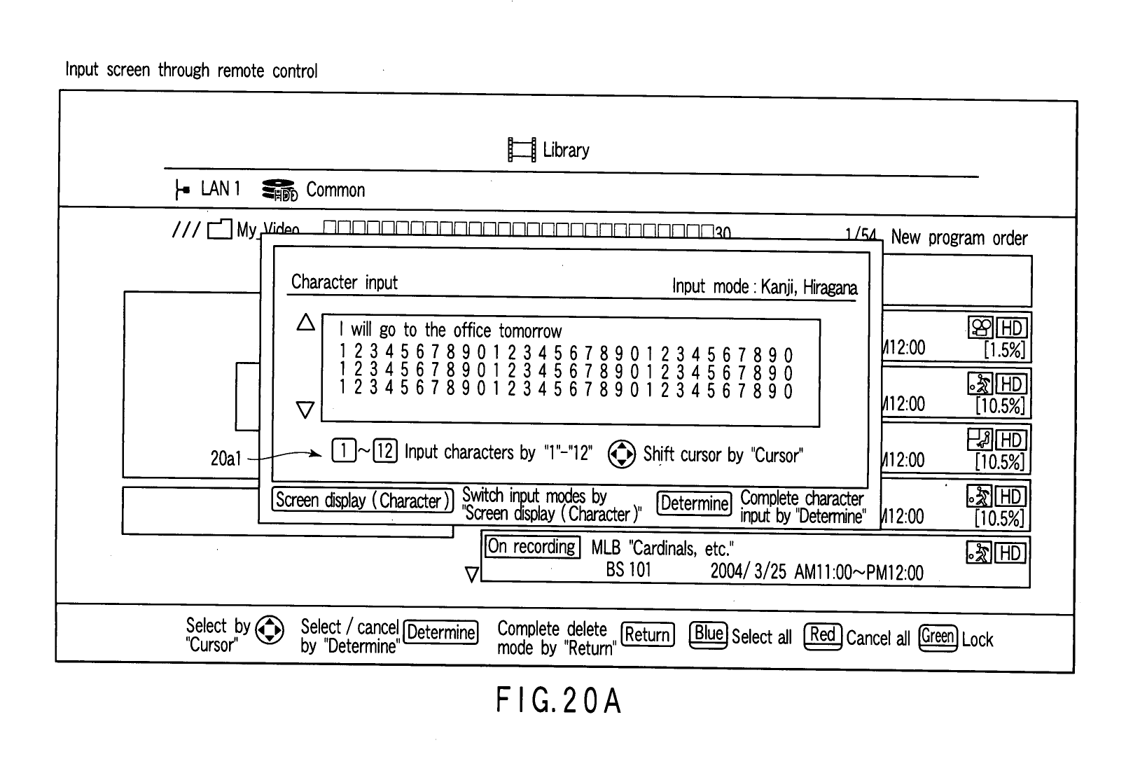

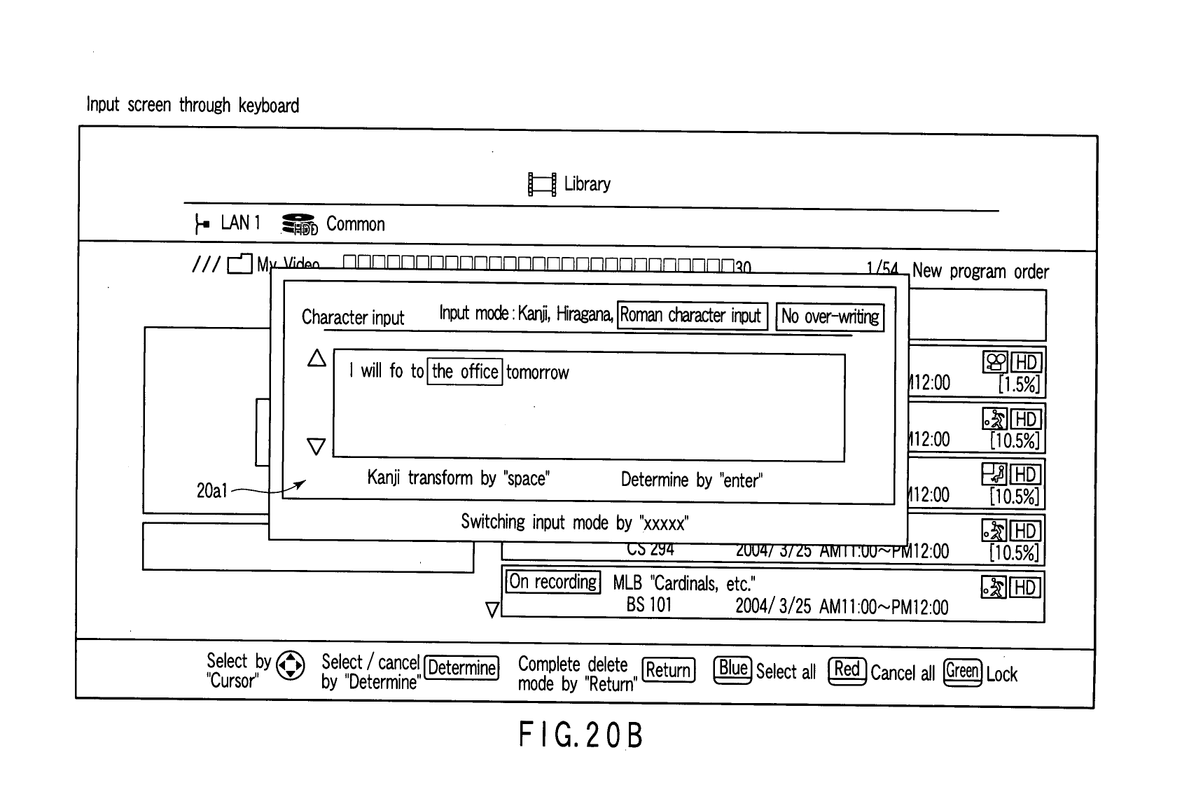

FIG. 20A shows a remote control input screen during the operation of the remote controller 17, and FIG. 20B shows an input screen during the operation of the keyboard 191. The user can provides the input information to the broadcast receiver 11 while confirming the operating unit in operation by the user itself and realizing the operation. In the case of the input screen through the remote controller 17 (FIG. 20A), comments of the operation method is displayed in an identification area 20a1. For example, numeric character keys 1-12 indicate that characters can be input thereby and cursor marks can shift the cursor key 17f. If the user inputs the characters, and finally operates the determination key 17g of the remote controller 17, the user can fix the input characters.

In the case of the input screen through the keyboard 191 (FIG. 20B), comments indicating that Kanji transform can be performed by using a “Space key” and that the Kanji transform can be fixed by using an “Enter” key. A part of the input screen indicating a screen different from the input screen through the remote controller 17, for example, such as an area indicating a current input method is also exists.

As mentioned above, the user can operate the broadcast receiver 11 while realizing the correspondence between the operating unit and the information input status on the screen by switching the display modes by the input screens through the keyboard 191 and the remote controller 17.

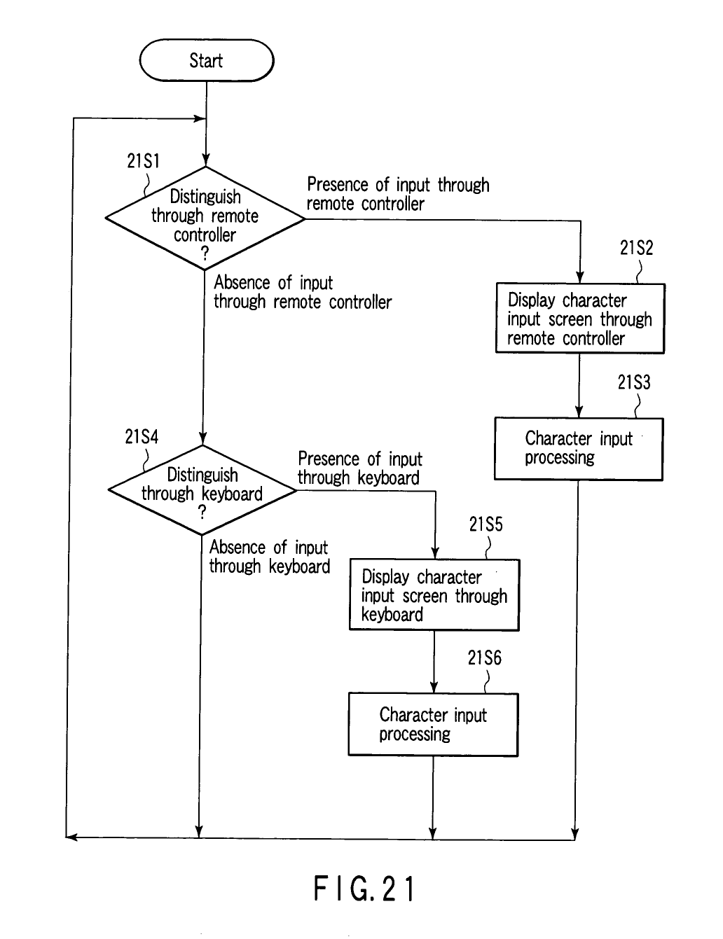

FIG. 21 shows the flowchart for performing operations to switch the input screens. The means to realize this flowchart is set, for example, as an operating unit, determining unit, an input screen switching unit and a character input processing unit in the control unit 56 in FIG. 1.

In FIG. 21, for example in a retrieval mode, any trigger is input into the remote-controlled operation receiving unit 18 (refer to FIG. 1) or the USB terminal, the determining operation is started. It is determined if any character is input through the remote controller 17 (block 21S1), if the character input through the remote controller 17 is confirmed, the broadcast receiver 11 displays the input screen through the remote controller 17 (FIG. 20A) (block 21S2). The character input processing operation through the remote controller 17 is then started (block 21S3).

If the character input through the remote controller 17 is not confirmed, it is determined if the character input through the keyboard 191 is confirmed (block 21S4). If the broadcast receiver 11 displays the input screen through the keyboard 191 (FIG. 20B)), the character input processing operations through the keyboard 191 are then started (blocks 21S5 and 21S6).

As stated above, according to this broadcast receiver 11, the user can operate through the keyboard 191 via the USB terminal as well as can operate through the remote controller 17 then the user can use any of the operating units. Thereby, the user can easily use the broadcast receiver 11 while switching the input screens of the operating unit.

Moreover, there is the case that the “retrieval” function is executed during the display of the library screen. In the event of specification of the “retrieval”, the operation shown in FIG. 21 is started. In the screens shown in FIG. 5 or FIG. 15, if the user operates, for example, the preset specific key, the operations shown in FIG. 21 may be started. For starting the operations shown in FIG. 21, a variety of modes can be adopted and an embodiment of the invention is not limited to the forgoing specific embodiment. A variety of modes such as a case of an E-mail reply and a case of an E-mail input may be implemented as for the embodiment. Though in the forgoing explanation, the remote controller is employed as a radio input and the keyboard is employed as a cable input, it is to be understood that the embodiment of the invention is not limited to the specific cases described above and a radio first character input means and a wired second character input means may be available for the character input means.

It is our intention that the invention is not limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be omitted from the whole of the constituent elements shown in the embodiments mentioned above. Further, the constituent elements over different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method comprising:
configuring the broadcast receiver to receive a first input signal supplied from a first character input device;
configuring the broadcast receiver to receive a second input signal from a second character input device; and
determining whether the broadcast receiver receives the first input signal from the first character input device or the second input signal from the second character input device; and
switching a mode of a display screen on a display unit from a first mode to a second mode in response to determining that the broadcast receiver is receiving the second input signal.

2. A method according to claim 1, wherein prior to switching the mode of the display screen, the method comprises:
placing the display screen in the first mode in response to determining that the broadcast receiver is receiving the first input signal.

3. A method according to claim 1 further comprising:
receiving and decoding a digital broadcast signal;
decoding the digital broadcast signal to reproduce a program; and
selectively outputting the decoded program to a plurality of sets of recordable digital recording equipment.

4. A method according to claim 1, wherein the switching of the mode of the display screen comprises:
switching an input screen of the display screen to a first input screen if the first input signal is detected; and
switching the input screen of the display screen to a second input screen if the first input signal is not detected and the second input signal is detected.

5. The method according to claim 1, wherein the first character input device is a remote controller.

6. The method according to claim 5, wherein the second character input device is a wired character input device.

7. The method according to claim 1, wherein the wired character input device is a keyboard.

8. A broadcast receiver, comprising:
a display unit including a display screen;
a remote-controlled operation receiving unit;
an universal serial bus (USB) terminal;
an input discrimination unit adapted to detect a presence of input signaling through the remote-controlled operation receiving unit and a presence of input signaling through the USB terminal; and
a display mode switching unit in communication with the input discrimination unit, the display mode switching unit being adapted to switch a mode of an input screen displayed on the display screen based on whether input signaling is detected through the remote-controlled operation receiving unit or through the USB terminal.

9. A broadcast receiver according to claim 8 further comprising:
receiving means for receiving a digital broadcast signal;
processing means for decoding to reproduce a program from the received digital broadcast signal; and
a plurality of input/output devices to selectively output the decoded program to selected recording equipment.

10. A broadcast receiver according to claim 8 further comprising:
a character input processing unit adapted to process the input signaling received through the remote-controlled operation receiving unit or the input signaling received through the USB terminal.

11. A broadcast receiver according to claim 8, wherein the USB terminal is coupled to a keyboard.

12. A broadcast receiver according to claim 11, wherein in the remote-controlled operation receiving unit receives wireless signals from a remote controller.

13. A broadcast receiver according to claim 8, wherein display mode switching unit switches the mode of the input screen by (i) switching to a first input screen configuration if the input signaling is received through the remote-controlled operation receiving unit, and (ii) switching to a second input screen configuration if the input signaling is not detected through the remote-controlled operation receiving unit and is detected through the USB terminal.

14. A broadcast receiver according to claim 8, wherein the display screen of the display unit includes a display area for a comment directed to operations utilized for the mode of the input screen.

15. A method for a broadcast receiver adapted to receive a digital broadcast signal, reproduce a program from the received digital broadcast signal, output the recovered program to digital recording equipment, and receive inputs at a remote-controlled operation receiving unit and a universal serial bus (USB) terminal, comprising:
discriminating between character input signals received through the remote-controlled operation receiving unit and through the USB terminal;
switching modes of a display screen of a display unit in response to whether the broadcast receiver receives a character input signal through the remote-controlled operation receiving unit or a character input signal through the USB terminal; and
processing the character input signals from the remote-controlled operation receiving unit and the USB terminal.

16. The method according to claim 15, wherein the method further displaying a comment indicating an operation method on the display screen of the display unit in response to the discriminating operation.
